(19) United States
(12) Patent Application Publication
(10) Pub. No.: US 2025/0311761 A1
(43) Pub. Date: Oct. 9, 2025

(54) METHOD FOR THE PREPARATION OF A NUTRITIONAL POWDER

(71) Applicant: SOCIETE DES PRODUITS NESTLE S.A., Vevey (CH)

(72) Inventors: VIRGINIE MARTINET, Utzigen (CH); THIBAUT DUTTER, Amersfoort (NL); ANNE THEVENIER, Bern (CH); GREGOIRE RICARD, Villars-sur-Glane (CH); TIMOTHE LEMAIRE, Ostermundigen (CH); MONIKA RAPP, Zollikofen (CH)

(21) Appl. No.: 18/866,428

(22) PCT Filed: May 17, 2023
(86) PCT No.: PCT/EP2023/063325

§ 371 Date: Nov. 15, 2024

(30) Foreign Application Priority Data
May 18, 2022 (EP) 22173973.3

(51) Int. Cl. A23L 33/175; A23J 3/30; A23L 29/212; A23L 33/00; A23L 33/115; A23L 33/18

(52) U.S. Cl. CPC A23L 33/175; A23J 3/30; A23L 29/212; A23L 33/115; A23L 33/18; A23L 33/40

(57) ABSTRACT

The present invention relates to a method for the preparation of a nutritional powder comprising free amino acids and/or extensively hydrolyzed protein as well as to a nutritional powder obtained by said method. The present invention further relates to the use of a carbohydrate to improve the sensorial properties of a nutritional composition comprising free amino acids and/or extensively hydrolyzed protein.

### TECHNICAL FIELD

The present invention relates to a method for the preparation of a nutritional powder comprising free amino acids and/or extensively hydrolyzed protein as well as to a nutritional powder obtained by said method. The present invention further relates to the use of a carbohydrate to improve the sensorial properties of a nutritional composition comprising free amino acids and/or extensively hydrolyzed protein.

### BACKGROUND OF THE INVENTION

Nutritional powders that comprise free amino acids and/or extensively hydrolyzed protein often show an unfavorable bitter taste or an undesirable hydrolyzed flavor that is based on the presence of the free amino acids and/or extensively hydrolyzed protein. However, in some cases it is not avoidable to use free amino acids and/or extensively hydrolyzed protein in nutritional powders, for example, in nutritional compositions that are used for the dietary management of food allergies such as cow's milk allergy.

Hence, there is a need for the provision of a method that allows the preparation of nutritional powders that comprise free amino acids and/or extensively hydrolyzed protein, but that have improved sensorial properties, in particular with regard to a reduced bitterness perception and/or a reduced perception of a hydrolyzed flavor.

Moreover, such a method shall not compromise other important characteristics of the produced nutritional powder such as the dissolving properties of the nutritional powder.

### DESCRIPTION OF THE FIGURES

FIG. 1. SEM-image of pre-gelatinized potato starch.

FIG. 2. SEM-image of a nutritional powder sample prepared by wet-processing and spray-drying.

FIG. 3. SEM-image of a nutritional powder sample prepared by wet-processing and spray-drying, wherein 3 wt. % of pre-gelatinized starch has been added during spray-drying.

FIG. 4. SEM-image of a nutritional powder sample prepared by wet-processing and spray-drying, wherein 5 wt. % of pre-gelatinized starch has been added during spray-drying.

FIG. 5. SEM-image of a nutritional powder sample prepared by wet-processing and spray-drying, wherein 10 wt. % of pre-gelatinized starch has been added during spray-drying.

FIG. 6. SEM-image of a nutritional powder sample prepared by wet-processing and spray-drying, wherein 5 wt. % of pre-gelatinized starch has been added after spray-drying by dry-mixing.

### DESCRIPTION OF THE INVENTION

The invention relates to a process for the preparation of a nutritional powder comprising free amino acids and/or extensively hydrolyzed protein, comprising the steps of:
preparing a liquid concentrate comprising free amino acids and/or extensively hydrolyzed protein;
spray-drying the liquid concentrate to form a nutritional powder, wherein the spray-drying of the liquid concentrate is performed in the presence of solid carbohydrate particles.

The method according to the invention is for the preparation of a nutritional powder. Under “nutritional powder”, a powdered composition is understood that is intended to be reconstituted with a liquid, preferably water, before consumption.

In a particular embodiment, the nutritional powder is an infant formula, a growing up milk, an instant milk powder, a functional milk, a healthcare formula, an instant soup, or an instant sauce.

In a particular embodiment, the nutritional powder is an infant formula, an instant milk powder, or a healthcare formula. Preferably, the nutritional powder is an infant formula.

According to the invention, the nutritional powder comprises free amino acids and/or extensively hydrolyzed protein.

Under the term “free” amino acids, amino acids are understood that are present in the nutritional powder in free form, i.e. they are not bound e.g. to other amino acids via peptide bonds.

Under “amino acids”, both amino acids as well as their respective salts are understood.

In a particular embodiment, the amino acids are L-amino acids. A person skilled in the art will appreciate that all naturally occurring amino acids are in L-form.

In a particular embodiment, the amino acids are D-amino acids.

In a particular embodiment, at least one of the amino acids is an amino acid having a bitter taste. It lies within the knowledge of a skilled person to determine whether an amino acid confers a bitter taste or not. For example, potential bitterness of an amino acid may be determined by dissolving an amino acid in water and assessing its potential bitterness in a sensory study. The potential bitterness of an amino acid may be determined, for example, by the methods described in Kawai, M., Sekine-Hayakawa, Y., Okiyama, A. et al. Gustatory sensation of L- and D-amino acids in humans. Amino Acids 43, 2349-2358 (2012). Examples for amino acids that confer a bitter taste are L-leucin, L-isoleucine, L-phenylalanine, L-tryptophan and L-histidine.

In a particular embodiment, the amino acids are selected from the following amino acids or salts thereof: L-lysine, L-leucine, L-proline, L-glutamine, L-arginine, L-valine, glycine, L-isoleucine, L-threonine, L-serine, L-phenylalanine, L-tyrosine, L-aspartic acid, L-histidine, L-alanine, L-cystine, L-aspartate, L-tryptophan, L-methionine, magnesium L-aspartate, L-lysine acetate, and L-Arginine-L-Aspartat.

Under the term “extensively hydrolyzed protein”, protein is understood that has been subjected to an extensive hydrolyzation step. The hydrolysis can be carried out by any suitable method known to a person skilled in the art such as e.g. acid hydrolysis or enzymatic hydrolysis.

Extensively hydrolyzed protein is characterized by a non-protein nitrogen (NPN) to total nitrogen (TN) ratio of above 95%, i.e. extensively hydrolyzed protein meets the following ratio:

$$( NPN / TN ) \times 100 \% > 95 \%$$

A skilled person knows how to determine the amount of non-protein nitrogen (NPN) and total nitrogen (TN) in a hydrolyzed protein mixture. For example, the amount of total nitrogen (TN) can be determined by the Kjeldahl method. The non-protein nitrogen (NPN) can be determined by measuring the total nitrogen content upon precipitation of proteins, e.g. in trichloroacetic acid.

As it will be appreciated by a person skilled in the art, extensively hydrolyzed protein has a certain off-flavor note is well known by a skilled person and that may be referred to as “hydrolyzed flavor” or “peptide flavor” that is unfavorable for a nutritional powder from a consumer perspective. Moreover, in view of the extensive hydrolyzation, free amino acids will be present in extensively hydrolyzed protein that may confer a bitter taste to the nutritional powder. In extensively hydrolyzed protein, the same free amino acids may be present as described above in the context of the embodiments for naturally occurring free amino acids. Further, also smaller amounts of bitter-tasting peptides may be present in extensively hydrolyzed protein that likewise may confer an undesirable bitter taste.

The method according to the invention comprises the step of preparing a liquid concentrate comprising free amino acids and/or extensively hydrolyzed protein. This means that a liquid concentrate is prepared by dissolving free amino acids and/or extensively hydrolyzed protein in an aqueous solution, preferably in water.

In a particular embodiment, a liquid concentrate is prepared that comprises free amino acids.

In a particular embodiment, a liquid concentrate is prepared that comprises extensively hydrolyzed protein.

In a particular embodiment, a liquid concentrate is prepared that comprises both free amino acids and extensively hydrolyzed protein.

In a particular embodiment, the liquid concentrate further comprises carbohydrates selected from the group consisting of maltodextrin, maltose, sucrose, glucose syrup, lactose, starch, and a mixture thereof. Preferably, the liquid concentrate comprises glucose syrup. Preferably, the glucose syrup has a DE (dextrose equivalent) between 10-30, more preferably between 20-23. A skilled person knows suitable methods how to determine the DE-value of a glucose syrup. Preferably, the starch is native starch, more preferably native potato starch. Alternatively, the starch could also be pre-cooked starch.

In a particular embodiment, the liquid concentrate further comprises salts and/or minerals. Preferably, the salts are selected from the group consisting of calcium glycerophopsphate, potassium chloride, sodium citrate, calcium citrate, potassium citrate, sodium phosphate, magnesium oxide, ferrous sulphate, zinc sulphate, copper sulphate, potassium iodide, manganese sulphate, and sodium selenite.

In a particular embodiment, the liquid concentrate further comprises vitamins. Preferably, the vitamins are selected from the group consisting of vitamin C, vitamin E, niacin, pantothenic acid, riboflavin A, thiamin, vitamin B6, folic acid, vitamin K, vitamin D, biotin, and vitamin B12.

In a particular embodiment, the liquid concentrate further comprises human milk oligosaccharides (HMOs).

In a particular embodiment, the liquid concentrate further comprises an emulsifier. Preferably, the emulsifier is based on citric acid esters of mono- and diglycerides (Citrem)

In a particular embodiment, the liquid concentrate further comprises an acidity regulator. Preferably, the acidity regulator is citric acid.

In a particular embodiment, the liquid concentrate further comprises polyunsaturated fatty acids such as docosahexaenoic acid (DHA) and arachidonic acid (ARA).

In a particular embodiment, the liquid concentrate further comprises taurine.

In a particular embodiment, the liquid concentrate further comprises inositol.

In a particular embodiment, the liquid concentrate further comprises L-carnitine.

In a particular embodiment, the ingredients in the liquid concentrate are not heat-sensitive. Typical ingredients being present in the liquid concentrate (wet ingredients) such as emulsifiers, lipids, vitamins, and minerals are usually not heat sensitive.

In a particular embodiment, the liquid concentrate has a solid content of at least 35 wt. %, based on the total weight of the liquid concentrate.

In another particular embodiment, the liquid concentrate has a solid content of at least 40 wt. %, based on the total weight of the liquid concentrate.

In another particular embodiment, the liquid concentrate has a solid content of at least 50 wt. %, based on the total weight of the liquid concentrate.

Up to the point where the liquid concentrate is spray-dried to form the nutritional powder, the liquid concentrate may undergo further process steps that are well-known to a skilled person.

In a particular embodiment, the ingredients in the liquid concentrate (wet ingredients) are standardized, i.e. certain concentrations of the ingredients are adjusted.

In a particular embodiment, the liquid concentrate is thermally treated to reduce bacterial loads. This may be carried out by steam injection or by a heat exchanger. Afterwards, the liquid concentrate may be cooled.

In a particular embodiment, the liquid concentrate may be homogenized. A homogenization step may be suitable to obtain a stable emulsion in case the liquid concentrate comprises a polar and a non-polar phase that are not miscible. Suitable equipment for the homogenization of the liquid concentrate is well known to a skilled person. Moreover, the process according to the invention may also comprise more than one homogenization step, for example, two homogenization steps.

In a particular embodiment, the liquid concentrate is subjected to an evaporation step. Such an evaporation step may be suitable to produce a liquid concentrate with a desired solid content before the spray-drying is carried out. The evaporation step may lead to a liquid concentrate that has a solid content of at least 35 wt. %.

According to the inventive process, the spray-drying of the liquid concentrate is performed in the presence of solid carbohydrate particles.

In a particular embodiment, the liquid concentrate is sprayed into the top of a spray-drier, preferably with high-pressure swirl nozzles. The atomization pressure is typically between 50 to 300 bar, preferably 160 to 210 bar with the hot air being introduced at a temperature between 15° and 400° C., preferably between 25° and 340° C. Suitable spray-driers and spray-drying conditions are well known to a skilled person.

Suitable blowing equipment may be used to transport the solid carbohydrate particles into the spray-drier. Air blowers are particularly suitable. Alternatively, the dry ingredients may be mechanically transported to the spray-drier.

The location in the spray dryer at which the solid carbohydrate particles are introduced is not critical.

In a particular embodiment, the solid carbohydrate particles are blown into the zone of turbulence of the spray dryer. The precise location of this zone varies with the type of spray dryer, but the location and extent of the zone of turbulence of any given spray dryer will be well known to a person skilled in the art. Preferably, the zone of turbulence refers to the zone in the spray dryer where the agglomeration of the particles takes place.

In another particular embodiment, the solid carbohydrate particles may be introduced into the exhaust air ducts of the spray dryer.

Once introduced into the spray drier, the solid carbohydrate particles may agglomerate with the drying particles of the liquid concentrate to produce a homogeneous powdered product.

Hence, in particular embodiment, the liquid concentrate and the solid carbohydrate particles form agglomerates during spray-drying.

Most spray dryers are equipped with a device to allow the re-introduction of so-called “fines” into the spray dryer. Fines are particles produced in the spray dryer that are smaller than desired for the final product resulting, for example, from the breakdown of agglomerated particles produced during spray drying. These small particles can be collected, for example by filtration, and can be blown back into the spray dryer to re-agglomerate with newly introduced liquid concentrate. This process is known as “blowing back”. If a spray dryer is equipped with apparatus for blowing back fines, this device may advantageously also be used for the introduction of the solid carbohydrate particles.

In a particular embodiment, the solid carbohydrate particles are selected from the group consisting of maltodextrin, maltose, sucrose, glucose syrup, lactose, starch, and a mixture thereof. Preferably, the solid carbohydrate particles are solid starch particles, more preferably pre-gelatinized starch particles. Under “pre-gelatinized” starch, a starch is understood that has been cooked and dried to render the starch water-soluble without the need for further heating to dissolve the starch. Pre-gelatinized starch has the advantage that it can effectively provide viscosity to the reconstituted nutritional powder. Preferably, the starch is potato starch. The use of solid starch particles is particularly preferred, as it has not only a positive influence on the taste of the nutritional powder when being added during spray-drying, but also higher total amounts of starch can be introduced into the nutritional powder, as the amount of starch that can be added into the liquid concentrate is rather limited in view of the viscosity increasing effects of starch that may hamper the subsequent spray-drying of the liquid concentrate. In theory, the solid starch particles could also be added to the powder that is obtained upon spray-drying of the liquid concentrate. However, the solubility of the nutritional powders would be significantly compromised, which is not an option for this kind of nutritional products. Without being bound by theory, it is assumed that the agglomeration that takes place between the spray-dried liquid concentrate and the solid starch particles results in improved dissolvability of the nutritional powder during reconstitution.

Apart from the solid carbohydrate particles, also other dry ingredients may be present during spray-drying of the liquid concentrate. This is particularly favorable for ingredients that are heat sensitive by themselves or for ingredients that may have an influence on the stability of other ingredients being present in the liquid concentrate. For example, degradation of vitamin C can be expected if vitamin C is added to the liquid concentrate that is subsequently spray dried and that is potentially also subjected to other heat operations (such as evaporation) before the spray-drying step. Moreover, undesirable oxidation reactions between some minerals and lipid components may be minimized by choosing to add some minerals only during the spray-drying step. In this regard, also calcium glycerophosphate may be added during the spray-drying step.

In a particular embodiment, the process according to the invention results in a nutritional powder that comprises from 9.5 to 18 wt. % free amino acids and/or extensively hydrolyzed protein, based on the total weight of the nutritional powder. Preferably, the nutritional powder comprises from 10 to 17 wt. % of free amino acids and/or extensively hydrolyzed protein, more preferably from 11 to 14 wt. %.

In a particular embodiment, the process according to the invention results in a nutritional powder that comprises from 40 to 55 wt. % carbohydrates, based on the total weight of the nutritional powder. This includes both carbohydrates added during wet processing (present in the liquid concentrate) and carbohydrates that have been added as solid particles during spray-drying of the liquid concentrate. Preferably, the carbohydrates are selected from the group consisting of maltodextrin, maltose, sucrose, glucose syrup, lactose, starch, and a mixture thereof.

In a particular embodiment, the solid carbohydrate particles added during spray-drying amount to from 3 to 10 wt. % based on the total weight of the nutritional powder, preferably from 3 to 5 wt. %. This means that the given amounts of carbohydrates in the final powder are based on the addition of said carbohydrates as solid particles during the spray-drying step.

In a particular embodiment, the process according to the invention results in a nutritional powder that comprises from 20 to 30 wt. % of total fat, and/or a maximum ash amount of 4 wt. %, and/or a maximum water content of 4 wt. %, based on the total weight of the nutritional powder. This includes both the ingredients being added during wet processing (present in the liquid concentrate) and being added during spray-drying of the liquid concentrate.

Preferably, the nutritional powder comprises from 22 to 28 wt. % of total fat, based on the total weight of the nutritional powder.

Preferably, the ash amount is between 1 and 4 wt. %, based on the total weight of the nutritional powder.

Preferably, the water content is between 1 and 4 wt. %, based on the total weight of the nutritional powder.

In another embodiment, the nutritional powder comprises a maximum water content of 3.5 wt. %, based on the total weight of the nutritional powder, preferably 3 wt. %.

The present invention also relates to a nutritional powder obtained by the process according to the invention.

In view of the process for its preparation, the nutritional powder comprises agglomerates comprising free amino acids and/or extensively hydrolyzed protein as well as carbohydrates. The agglomerated structure leads to improved dissolving properties of the nutritional powder compared to simply dry-mixing of spray-dried powder and solid carbohydrate particles. Moreover, without being bound by theory, it is assumed that it is the agglomerated structure that results in a reduction of the bitter off-taste of the nutritional powder upon reconstitution.

In a particular embodiment, the nutritional powder comprises agglomerates of free amino acids and/or extensively hydrolyzed protein and carbohydrates selected from the group consisting of maltodextrin, maltose, sucrose, glucose syrup, lactose, starch, and a mixture thereof. Preferably, the nutritional powder comprises agglomerates of free amino acids and/or extensively hydrolyzed protein and starch, preferably pre-gelatinized starch.

In a particular embodiment, the nutritional powder comprises agglomerates of free amino acids and carbohydrates selected from the group consisting of maltodextrin, maltose, sucrose, glucose syrup, lactose, starch, and a mixture thereof. Preferably, the nutritional powder comprises agglomerates of free amino acids and starch, preferably pre-gelatinized starch.

In a particular embodiment, the nutritional powder comprises agglomerates of extensively hydrolyzed protein and carbohydrates selected from the group consisting of maltodextrin, maltose, sucrose, glucose syrup, lactose, starch, and a mixture thereof. Preferably, the nutritional powder comprises agglomerates of extensively hydrolyzed protein and starch, preferably pre-gelatinized starch.

In a particular embodiment, the nutritional composition has a viscosity of between 2.5 to 17 mPas/s at a shear rate of 100 s⁻¹ and a temperature of 70° C. when dissolved at a concentration of 87 wt. % in water.

In a particular embodiment, the nutritional powder comprises from 9.5 to 18 wt. % free amino acids and/or extensively hydrolyzed protein, based on the total weight of the nutritional powder. Preferably, the nutritional powder comprises from 10 to 15 wt. % of free amino acids and/or extensively hydrolyzed protein, more preferably from 12 to 14 wt. %.

In a particular embodiment, the nutritional powder comprises carbohydrates in an amount of from 40 to 55 wt. %, based on the total weight of the nutritional powder.

In a particular embodiment, the nutritional powder comprises from 20 to 30 wt. % of total fat. Preferably, the nutritional powder comprises from 22 to 28 wt. % of total fat, based on the total weight of the nutritional powder. Preferably, the nutritional powder comprises polyunsaturated fatty acids such as docosahexaenoic acid (DHA) and arachidonic acid (ARA).

In a particular embodiment, the nutritional powder comprises a maximum ash amount of 4 wt. %, based on the total weight of the nutritional powder. Preferably, the ash amount is between 1 and 4 wt. %, based on the total weight of the nutritional powder.

In a particular embodiment, the nutritional powder comprises a maximum water content of 4 wt. %, based on the total weight of the nutritional powder. Preferably, the water content is between 1 and 4 wt. %, based on the total weight of the nutritional powder.

In another embodiment, the nutritional powder comprises a maximum water content of 3.5 wt. %, based on the total weight of the nutritional powder, preferably a maximum water content of 3 wt. %.

In another embodiment, the nutritional powder comprises salts and/or minerals. Preferably, the salts are selected from the group consisting of calcium glycerophopsphate, potassium chloride, sodium citrate, calcium citrate, potassium citrate, sodium phosphate, magnesium oxide, ferrous sulphate, zinc sulphate, copper sulphate, potassium iodide, manganese sulphate, and sodium selenite).

In another embodiment, the nutritional powder comprises vitamins. Preferably, the vitamins are selected from the group consisting of vitamin C, vitamin E, niacin, pantothenic acid, riboflavin A, thiamin, vitamin B6, folic acid, vitamin K, vitamin D, biotin, and vitamin B12.

In a particular embodiment, the nutritional powder comprises human milk oligosaccharides (HMOs).

In a particular embodiment, the nutritional powder comprises an emulsifier. Preferably, the emulsifier is based on citric acid esters of mono- and diglycerides.

In a particular embodiment, the nutritional powder comprises an acidity regulator. Preferably, the acidity regulator is citric acid.

In a particular embodiment, the nutritional powder comprises taurine.

In a particular embodiment, the nutritional powder comprises inositol.

In a particular embodiment, the nutritional powder comprises L-carnitine.

It is to be understood that the embodiments given above for the process according to the invention also apply to the nutritional powder obtained by the process according to the invention.

The present invention also relates to the use of the process according to the invention for improving the sensorial impression of the nutritional composition, in particular for increasing the mouthfeel and/or reducing off-taste, such as bitterness, of the nutritional composition.

The present invention also relates to the use of a carbohydrate to improve the sensorial properties of a nutritional composition comprising free amino acids and/or extensively hydrolyzed protein.

In a particular embodiment, the sensorial improvement refers to a reduction of the bitter taste of the nutritional composition and/or to the improvement of the mouthfeel of the nutritional composition.

In a particular embodiment, the carbohydrate is selected from the group consisting of maltodextrin, maltose, sucrose, glucose syrup, lactose, starch. Preferably, the carbohydrate is starch, more preferably pre-gelatinized starch.

### EXAMPLES

### Example 1: Preparation of Spray-Dried Nutritional Powders

The following recipes were used for the preparation of spray-dried nutritional powders (Table 1):

| Ingredient | | | | |
|---|---|---|---|---|
| (g/100 g | | | | |
| powder | | | | |
| finished | Sample 1 | | | |
| product) | (control) | Sample 2 | Sample 3 | Sample 4 |
| Glucose syrup | 48 | 45 | 43 | 38 |
| (DE 20-23) | | | | |
| Amino acid mix | 13.85 | | | |
| Native potato | 4.97 | | | |
| starch | | | | |
| Vitamin/mineral-/ | 8.28 | | | |
| HMO-Mix | | | | |
| Oil mix & PUFA | 24.9 | | | |
| mix & Citrem | | | | |
| Pre-gelatinized | 0 | 3 | 5 | 10 |
| potato starch | | | | |
| added during | | | | |
| spray drying | | | | |

The amino acid mix had the following composition:

| | |
|---|---|
| s L-Alanine | 4.1900% |
| s L-Arginine | 7.4100% |
| s L-Aspartic Acid | 5.0100% |
| s Magnesium L-Aspartate | 2.9300% |
| s Glycine INS640 | 6.5200% |
| s L-Histidine | 4.2600% |
| s L-Isoleucine | 6.5200% |
| s L-Leucine | 11.2000% |
| s L-Lysine Acetate | 11.9300% |
| s L-Methionine | 1.7900% |
| s L-Phenylalanine | 5.0200% |
| s L-Proline | 7.9600% |
| s L-Serine | 5.4200% |
| s L-Threonine | 5.4900% |
| s L-Tryptophan | 2.1900% |
| s L-Tyrosine | 5.0200% |
| s L-Valine | 7.1400% |

The Vitamin/mineral/HMO-mix had the following composition:

| | |
|---|---|
| s Manganese Sulfate (II) | 0.0016% |
| s Potassium Iodide | 0.0016% |
| s Sodium Selenate | 0.0007% |
| s Vitamin A Acetate | 0.0087% |
| s Vitamin D3 (Cholecalciferol) | 0.0001% |
| s Vitamin E (DL-Alpha-Tocopheryl Acetate) | 0.1237% |
| s Vitamin K1 (Phytomenadione) | 0.0005% |
| s Vitamin C (Sodium Ascorbate) INS301 | 1.2128% |
| s Vitamin B1 (Thiamine Mononitrate) | 0.0076% |
| s Vitamin B2 (Riboflavin INS101i) | 0.0114% |
| s Nicotinamide | 0.0741% |
| s Vitamin B6 (Pyridoxine Hydrochloride) | 0.0060% |
| s Vitamin B9 (Folic Acid) | 0.0008% |
| s Vitamin B5 (Calcium D-Pantothenate) | 0.0393% |
| s Vitamin B12 (Cyanocobalamine) | 0.0000% |
| s Vitamin B7 (D-Biotin) | 0.0001% |
| s Inositol (Myo Inositol) | 0.4058% |
| s Taurine | 0.4775% |
| s Calcium Glycerophosphate INS383 | 24.9594% |
| s Potassium Chloride INS508 | 9.0097% |
| s Trisodium Citrate Dihydrate INS331iii | 5.7833% |
| s Potassium Citrate INS332ii | 3.0946% |
| s Sodium Dihydrogen Phosphate Dihydrate INS339i | 2.7597% |
| s Choline Bitartrate INS1001v | 3.5004% |
| s Magnesium Oxide INS530 | 0.3247% |
| s L-Carnitine | 0.0913% |
| s Lacto-N-Neotetraose | 4.1295% |
| s 2′-Fucosyllactose | 7.7922% |
| s Calcium Citrate INS333iii | 5.5984% |
| s Ferrous Sulfate | 0.1412% |
| s Copper Sulfate | 0.0103% |
| s Zinc Sulfate | 0.1273% |
| s L-Cystine | 4.7277% |
| s L-Glutamine | 11.2098% |
| s Maltodextrin Gluten Free | 14.3681% |

The fat mix had the following composition:

| | |
|---|---|
| s Oil Sunflower | 22.26% |
| s Oil Rapeseed Low Erucic Acid | 16.70% |
| s Oil Sunflower High Oleic | 6.96% |
| s Oil Palm Palmitic Acid sn-2 | 9.74% |
| s Oil Rapeseed Low Erucic Acid | 5.50% |
| s Oil Sunflower High Oleic | 5.30% |
| s Oil Schizochytrium sp | 1.30% |
| s Oil Fungal High ARA - Type ARASCO | 1.48% |
| s Medium Chain Triglycerides | 24.71% |
| s Citric and Fatty Acid Esters of Glycerol INS472c | 6.02% |
| s Tocopherol Concentrate Mixed INS307b | 0.0128% |
| s L-Ascorbyl Palmitate INS304 | 0.0148% |
| s Acid Citric INS330 | 0.0014% |

For the preparation of the above-mentioned nutritional powders, glucose syrup, the amino acid mix, native potato starch and the vitamin/mineral/HMO-mix have been dissolved/standardized in water. Then the mix of oil, Pufas, and Citrem has been dosed to the aqueous concentrate. Afterwards, the thus obtained mixture has been homogenized to prepare an emulsion by making use of a high shear homogenizer mixer.

Finally, the liquid concentrates have been subjected to spray drying to form nutritional powders. During spray drying, the hot air temperature was from 240-250° C., and the exhaust air temperature was from 83.5-84° C.

It can be observed from Table 1 that in Samples 2-4, pre-gelatinized potato starch has been added during spray-drying in different amounts. Sample 1 serves as a control, wherein no pre-gelatinized potato starch has been added during spray-drying.

The spray-dried samples with starch added during the spray-drying step, had the following characteristics (Table 2):

| | Sample 1 | Sample 2 | Sample 3 | Sample 4 |
|---|---|---|---|---|
| Water content | 2.05 | 1.98 | 2.19 | 2.39 |
| (wt. %) | | | | |
| Fat content (wt. %) | 25.51 | 25.81 | 25.08 | 26.47 |
| Protein content | 12.23 | 11.97 | 12.16 | 11.87 |
| (wt. %) | | | | |
| Ash content (wt. %) | 2.5 | 2.13 | 2.18 | 2.13 |
| Carbohydrate | 57.71 | 58.11 | 58.39 | 57.14 |
| content (wt. %) | | | | |

It is noted that further starch could not be added to the liquid concentrate, as the viscosity of the liquid concentrate become too high and spray-drying was no longer possible. Hence, the addition during spray-drying was the only possibility to add further starch to the samples compared to control sample 1.

### Example 2: Sensory Study

Samples 1 to 4 as prepared in Example 1 have been reconstituted in water at a level of 14.7 g/100 mL and have been evaluated in a sensory study (10 panelists, n=10).

In the sensory study, the bitterness, hydrolyzed flavor, and thickness of the reconstituted samples have been assessed. The evaluation of samples 2-4 has been made in comparison to the control sample (sample 1) based on a scale of −5 to +5. In case, a negative value has been found in comparison to the control sample, a certain attribute (bitterness, hydrolyzed flavor, or thickness) has been perceived as less pronounced. In case, a positive value has been found in comparison to the control sample, a certain attribute (bitterness, hydrolyzed flavor, or thickness) has been perceived as more pronounced.

The following results have been obtained as to the bitterness of the samples (Table 3):

| Sample | Mean value |
|---|---|
| Sample 1 (control) | 0 |
| Sample 2 | −0.59 |
| Sample 3 | −0.76 |
| Sample 4 | −0.77 |

It can be observed from Table 3 that Samples 2-4 were perceived less bitter than the control sample (Sample 1). This allows the conclusion that the addition of pre-gelatinized potato starch resulted in a reduction of the bitter taste of the reconstituted nutritional powders.

The following results have been obtained as to the hydrolyzed flavor of the samples (Table 4):

| Sample | Mean value |
|---|---|
| Sample 1 (control) | 0 |
| Sample 2 | −0.62 |
| Sample 3 | −0.82 |
| Sample 4 | −0.76 |

It can be observed from Table 4 that less of a hydrolyzed flavor was perceived for Samples 2-4 compared to the control sample (Sample 1). This allows the conclusion that the addition of pre-gelatinized potato starch resulted in a reduction of the hydrolysed flavor of the reconstituted nutritional powders.

The following results have been obtained as to the thickness of the samples (Table 5):

| Sample | Mean value |
|---|---|
| Sample 1 (control) | 0 |
| Sample 2 | 0.47 |
| Sample 3 | 0.80 |
| Sample 4 | 1.11 |

It can be observed from Table 5 that an increased thickness has been found for the samples, wherein starch has been added during spray-drying. Increased thickness can be expected to go along with an improved mouthfeel. It can also be observed that the higher the amount of added starch was, the higher was the perceived thickness.

However, sample 4, which showed the highest amount of added starch, was perceived as slightly slimy as compared to samples 2 and 3. Hence, samples 2 and 3 were considered to show the best overall results.

### Example 3: Scanning Electron Microscopy (SEM)

The nutritional powders of samples 1-4 have been assessed by Scanning Electron Microscopy as well as pre-gelatinized potato starch as a reference.

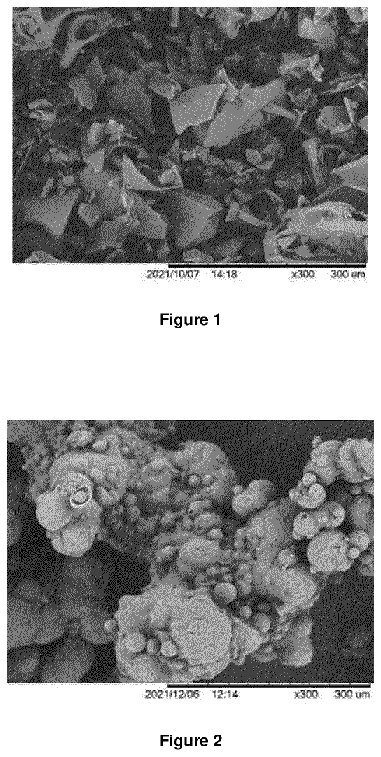

FIG. 1 shows SEM-image of pre-gelatinized potato starch. It can be observed that pre-gelatinized potato starch shows an angular structure similar to that of broken glass.

FIG. 2 shows the SEM-image of control sample 1. Hence, FIG. 2 shows the spray-dried powder structure of control sample 1, wherein no pre-gelatinized starch particles have been added and are also not observed (see FIG. 1 for comparison).

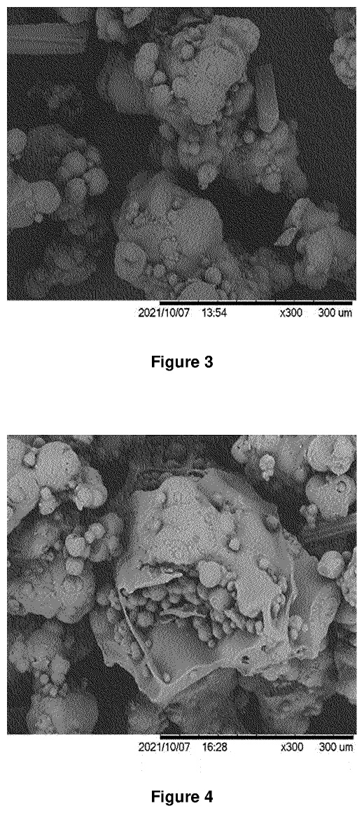

FIG. 3 shows the SEM-image of sample 2 (3 wt. % of further starch added). It can be observed that also the starch that has been added during spray-drying agglomerated well with the rest of the powder. This is considered proof that the addition of starch during spray-drying led to an agglomerated powder with an increased amount of starch.

FIG. 4 shows the SEM-image of sample 3 (5 wt. % of further starch added). It can be observed that also the starch that has been added during spray-drying agglomerated well with the rest of the powder.

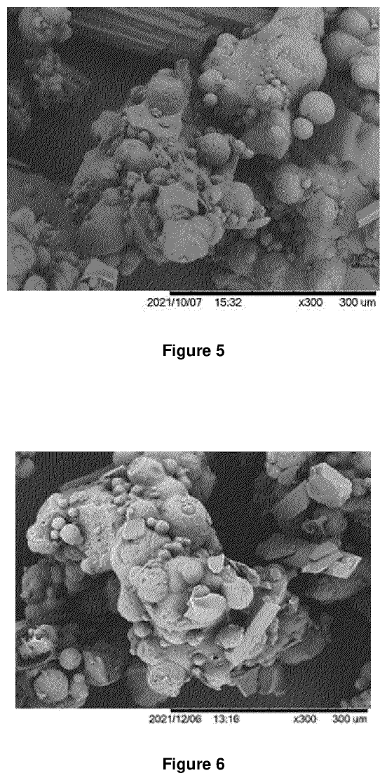

FIG. 5 shows the SEM-image of sample 4 (10 wt. % of further starch added). It can be observed that also the starch that has been added during spray-drying agglomerated well with the rest of the powder.

To test the influence of the addition of the starch during spray-drying on the formation of agglomerates, pre-gelatinized starch has also been added to the nutritional powder of Sample 1 by simply dry-mixing of the powder of Sample 1 with pre-gelatinized potato starch at a level of 5 wt. %. The thus obtained sample was referred to as comparative Sample 3, as in contrast to Sample 3 described above, the pre-gelatinized starch has not been added during spray-drying at a level of 5 wt. %, but rather after spray-drying by simple dry-mixing.

FIG. 6 shows the SEM-image of comparative sample 3. From FIG. 6 it can be derived that mere dry-mixing did not result in the formation of agglomerates, but rather free pre-gelatinized starch can be observed in FIG. 6 (see also FIG. 1 for comparison). By contrast, FIG. 4 as described above, shows that the addition of further starch at a level of 5 wt. % during spray-drying resulted in the formation of agglomerates.

1. A process for the preparation of a nutritional powder comprising free amino acids and/or extensively hydrolyzed protein, comprising the steps of:
preparing a liquid concentrate comprising free amino acids and/or extensively hydrolyzed protein;
spray-drying the liquid concentrate to form a nutritional powder, wherein the spray-drying of the liquid concentrate is performed in the presence of solid carbohydrate particles.

2. The process according to claim 1, wherein the nutritional powder comprises from 9.5 to 18 wt. % free amino acids and/or extensively hydrolyzed protein, based on the total weight of the nutritional powder.

3. The process according to claim 2, wherein the amino acids are selected from the group consisting of amino acids or salts thereof: L-lysine, L-leucine, L-proline, L-glutamine, L-arginine, L-valine, glycine, L-isoleucine, L-threonine, L-serine, L-phenylalanine, L-tyrosine, L-aspartic acid, L-histidine, L-alanine, L-cystine, L-aspartate, L-tryptophan, L-methionine, magnesium L-aspartate, L-lysine acetate, and L-Arginine-L-Aspartat.

4. The process according to claim 1, wherein the nutritional powder comprises from 40 to 55 wt. % carbohydrates, based on the total weight of the nutritional powder.

5. The process according to claim 4, wherein the carbohydrates are selected from the group consisting of maltodextrin, maltose, sucrose, glucose syrup, lactose, starch, and a mixture thereof.

6. The process according to claim 1, wherein the solid carbohydrate particles added during spray-drying amount to from 3 to 10 wt. % based on the total weight of the nutritional powder.

7. The process according to claim 1, wherein the nutritional powder comprises from 20 to 30 wt. % of total fat, and/or a maximum ash amount of 4 wt. %, and a maximum water content of 4 wt. %, based on the total weight of the nutritional powder.

8. The process according to claim 1, wherein the liquid concentrate has a solid content of at least 35 wt. %, based on the total weight of the liquid concentrate.

9. The process according to claim 1, wherein the solid carbohydrate particles are solid starch particles.

10. The process according to claim 1, wherein the nutritional powder is an infant formula, an instant milk powder, or a healthcare formula.

11. The process according to claim 1, wherein the solid carbohydrate particles are blown into the zone of turbulence of the spray dryer.

12. The process according to claim 1, wherein the liquid concentrate and the solid carbohydrate particles form agglomerates during spray-drying.

13. A method for improving the sensorial impression of the nutritional composition comprising preparing the product by a process for the preparation of a nutritional powder comprising free amino acids and/or extensively hydrolyzed protein, comprising the steps of:
preparing a liquid concentrate comprising free amino acids and/or extensively hydrolyzed protein;
spray-drying the liquid concentrate to form a nutritional powder, wherein the spray-drying of the liquid concentrate is performed in the presence of solid carbohydrate particles.

14.-16. (canceled)
